(19) United States
(12) Patent Application Publication
(10) Pub. No.: US 2005/0161287 A1
(43) Pub. Date: Jul. 28, 2005

(54) Device for height and gradient compensation

(76) Inventor: Roland Hosp, Bichlbach (AT)

Correspondence Address: BACHMAN & LAPOINTE, P.C., 900 CHAPEL STREET, SUITE 1201, NEW HAVEN, CT, 06510, US

(21) Appl. No.: 10/506,887

(22) PCT Filed: Mar. 5, 2003
(86) PCT No.: PCT/EP03/02247

(30) Foreign Application Priority Data
Mar. 7, 2002 (AT) A 355/02
Mar. 17, 2002 (AT) A 760/02

(51) Int. Cl. E06C 1/00

(52) U.S. Cl. 182/200

(57) ABSTRACT

A device for height and gradient compensation, characterized in that an arc-shaped bow is slidably disposed in an also arc-shaped guide tube, with the bow protruding from the guide tube preferably on both sides thereof.

The present invention relates to a device for height and gradient compensation; the present invention furthermore is concerned with such a device comprising an arc-shaped bow slidably arranged in a guide means, the bow protruding at least on one end from the guide means and this at least one bow end constituting a standing leg for the device, there being provided at least one additional supporting member.

Such devices are known from JP 11-081843 and JP 09-049382. As regards the gradient compensation mechanism, these devices are of complex construction and complicated in terms of handling. They require a fixing device for clamping the gradient compensation mechanism in the desired position. Especially the gradient compensation mechanism of JP 09-049382 is of complicated construction. The guide means for the arc-shaped bow are of movable design by means of a hinge and a spring connected thereto, such that they are capable of exerting a certain clamping force in the desired position. It is obviously only the spring force that maintains the clamping force on the bow, so that either the clamping force is not sufficient to ensure safe standing or the clamping force of the spring is so high that an adjustment of the bow is possible under exertion of high force only, accordingly diminishing the possibilities of use of this construction. Thus, this construction is provided with a fixing device as well.

The necessity to provide a possibility for rapidly and easily performing a height and gradient compensation often is present during work in the field. For example, it may be necessary in road works to erect provisional traffic signs on a location on a slope so as to be well visible.

There are already known various additional devices for horizontal orientation of a supporting surface above an uneven surface or ground. GB 2 361 942 A, for example, describes a method of establishing a horizontal plane on uneven ground, in which a supporting surface rests on a scaffolding of height-adjustable telescope supports. U.S. Pat. No. 4,884,791 also discloses a device for height compensation, comprising vertically adjustable supports adapted to be secured by fixing devices. Problematic in this context is the erection of the devices, involving much time and work; in addition thereto, the devices have to be fixed in the desired orientation.

In the light of the prior art outlined hereinbefore, in particular the two aforementioned Japanese publications, it is the object of the present invention to make available a device of the type described, which can be manufactured easily, permits simple handling and guarantees safe standing.

According to the invention, this object is met in that the bow is arranged at an angle with respect to the perpendicular such that, in use, it is fixed in the guide means under the influence of gravity.

The arrangement of the bow at an angle with respect to the perpendicular, i.e. with respect to the direction of gravity, permits the utilization of self-fixing or self-arresting properties of this construction for fixing the bow in use. On the other hand, the bow may be displaced easily in the guide means as soon as loads are removed from the device. Thus, utilization of this device is very simple and easy in practical application. The device is first brought to the proper position in the unloaded state. Upon subsequent loading thereof, the self-arresting forces enter into effect, thus ensuring the position of the device in safe and reliable manner.

It is to be pointed out that, with this construction, there are two different principles effecting the self-arresting feature. The one principle results due to the self-fixing effect of the bow in its guide means. Due to the arrangement of the bow at an angle with respect to the guide means, a torque is produced upon loading, pressing the bow against the guide means and thus effecting frictional fixation thereof. The second principle is based on the fact that, with the arrangement of the bow at an angle with respect to the perpendicular, adjustment of the device is possible only when the bearing points of the device are displaced relative to each other. This shall be outlined by way of an example in the following: for this example, let us consider a device in which the two bow ends and a strut constitute three standing legs of a three-legged structure and are joined to a plate or supporting surface. The stand is designed such that, when placed on a level ground, the bearing points of the bow ends and of the strut define an equal-sided triangle on the ground. If the bow were not arranged at an angle with respect to the perpendicular, lateral tilting of the plate of the stand would be possible quite easily; it would easily be possible that the guide means is displaced in relation to the stationary bow. Such a device would not be stable, and it would not work without fixing device. However, if the bow is arranged at an angle, e.g. of approx. 45° relative to the perpendicular, lateral tilting of the platform is not possible without changing the position of the bearing points on the ground. Or in other words, when the plate of the stand is arranged at an angle with respect to the horizontal surface in case of this construction, the bearing points define a skew triangle. The friction between the standing legs and the surface or ground on which the device is standing prevents tilting with respect to the horizontal surface. This effect is the stronger the higher the load acting on the device. This principle also works when the additional supporting member is a wheel, for example the wheel of a wheelbarrow. This principle also works in case the additional supporting member also is a bow guided in a guide means. It may be favorable to provide the standing legs of the device with friction-enhancing elements, e.g. rubber feet, earth nails etc.

It is thus recognizable that the device according to the invention is capable of ensuring a rapid and safe height and gradient compensation on a non-horizontal ground.

Preferably, both ends of the bow protrude from the guide means and constitute two standing legs for the device.

Preferably, the angle with respect to the perpendicular is between 30 and 60°, with approx. 45° being preferred in particular. Significantly smaller angles than 30° are not sufficient for safely fixing the device solely under the influence of gravity. Especially with relatively small angles between bow and perpendicular, the leverage ratios are so unfavorable that safe fixing is not possible.

Technically and economically advantageous aspects of the present invention are simple construction of the same, ensuring low susceptibility to repair situations at low manufacturing costs.

The height and gradient compensation is effected simply in that a bow end protruding from the guide tube is positioned on the low side and the other one on the high side, whereupon a supporting surface attached to the guide tube is aligned horizontally by adjustment of the guide tube. Due to the fact that the outer diameter of the bow substantially corresponds to the inner diameter of the guide tube, the bow is jammed in the guide tube under the inherent weight of the device, thereby frictionally fixing the same. Thus, there is no necessity for an additional fixation of the device.

In an advantageous development of the invention, there is provided an additional securing means against dynamic loads, such as e.g. vibrations.

Even more advantageous is an embodiment of the invention in which the plane of extension of the guide tube includes an angle of approx. 45° with the perpendicular to the bearing surface. This is advantageous for the stability of the device and at the same time leads to a high static load-carrying capacity.

An additional advantageous embodiment of the invention provides that the portions of the bow protruding from the guide tube each have a coil spring arranged thereon. This has the advantage that the bow, upon lifting of the device, is automatically brought into a middle position with respect to the guide tube, thus avoiding that the device has to be lifted unnecessarily high.

According to an additional embodiment of the invention there are at least two arc-shaped bows slidably arranged within one guide tube each, with the bows protruding from the respective guide tubes and the respective guide tubes being attached to a common supporting surface. This increases the supporting surface available, which may be constituted by the surface of a plate, for example. Particularly high stability results with this embodiment when the planes of the two guide tubes include an angle of approx. 90° with respect to each other.

A particularly advantageous embodiment of the invention results in that the device is preferably in rigid connection with a movable object. Thus, objects of daily use can be modified in simple and inexpensive manner for utilization thereof on uneven ground.

For example, it is particularly advantageous to attach a device according to the invention to a wheelbarrow. Tilting of the loaded wheelbarrow on uneven ground, for example a slope or a building site, can thus be avoided.

In addition thereto, it is expedient to attach a device according to the invention to a table trolley, especially when the same is designed as a machine supporting table. Conventional rocking saws, for example, are mostly provided with two wheels on a rigid axle and with two supporting legs. On uneven ground, conventional rocking saws have to be supported with the aid of supporting means in order to prevent an inclined position or even tipping over. When the supporting feet are replaced by the device according to the invention, such a tilting effect is prevented from the very beginning. By arranging coil springs on the portions of the bow protruding from the guide tube, it is not necessary to lift the saw unnecessarily high when it is lifted on one side so as to move the same on its wheels, since the bow automatically moves to its middle position.

A particularly advantageous embodiment results when the outer diameter of the bow substantially corresponds to the inner diameter of the guide tube. This provides for jamming of the bow in the guide tube, so that the bow is fixed in non-positive or frictional manner.

Particularly favorable frictional fixing of the bow in the guide tube results when the plane of extension of the guide tube forms an angle of preferably approx. 45° with respect to the perpendicular when the movable object is put down.

For improved fixing under dynamic loads, there may be provided an additional fixing device, for example in the form of a cotter pin or screws inserted through the bow in the center of the guide tube.

Another advantageous embodiment of the invention is created when the movable object is a ladder. During work on a building facade, it is often necessary to conduct such work standing on a ladder. If the wall section is located, for example, in the region of stairs, it is not possible for reasons of safety to compensate the difference in height upon erection of the ladder by placing inserts therebeneath. By using a ladder that is equipped with the device according to the invention, such work can be performed without danger. It is advantageous in this regard when the plane of extension of the guide tube includes an angle of preferably between 0° and 90°, in particular of approx. 25°, with the plane in which the ladder extends. Due to the fact that ladders are usually leaned against a house wall at an angle of approx. 70°, an advantageous angle of approx. 45° results between the guide tube and the perpendicular when the device is attached to the ladder at an angle of 25°.

In case the frictional fixing by jamming of the bow in the guide tube does not appear to be sufficient for reasons of safety, it is of course possible to provide an additional fixing device.

Of course, it would be possible in all of the embodiments to choose a design in which the bow is frictionally fixed in the guide tube under the influence of gravity. To this end, the inner diameter of the guide tube of course has to be larger than the outer diameter of the bow to such an extent that the frictional fixing effect can be released by lifting of the guide tube and the bow can be adjusted.

To reduce the overall weight of the device according to the invention, it is also possible to replace the guide tube by tube sections or rings.

Another advantageous embodiment of the invention results by manufacturing the device of weatherproof material. This ensures a long service life of the device when the same is used outdoors.

An additional advantageous embodiment of the invention results in that the supporting surface of circular or rectangular configuration has mounting means attached thereto for releasably mounting the objects placed on the supporting surface.

The invention relates in addition to a ladder, a road traffic sign, a wheelbarrow, a motorcycle, a table and a fence, each comprising a device according to the invention.

The device according to the invention is particularly suited for fences. In agriculture and in particular in horse keeping, it is often necessary to be able to quickly and flexibly set up fences that safely enclose a predetermined area. There are flexible systems working in somewhat reliable manner on horizontal ground. The setting up of such fences becomes problematic when the ground is uneven or inclined. According to the invention, a fence comprises vertical fence posts and horizontal fence members connected thereto, with a fence post being provided with a device according to the invention for placement on the ground. The device according to the invention preferably is designed as a three-legged structure, i.e. a bow along with an additional strut. It is particularly preferred to produce the fence members of a particularly lightweight and corrosion-resistant material. For example, aluminum is suitable therefor. The guide means and/or the bow may be coated with a plastics material to ensure enhanced sliding of the bow in the guide means. This applies also quite generally for the device according to the invention and other possibilities of use. As an alternative, material pairs may be chosen for the guide means and the bow that have particularly suitable sliding properties.

The invention and further developments of the invention will be described in the following with reference to the drawings in which

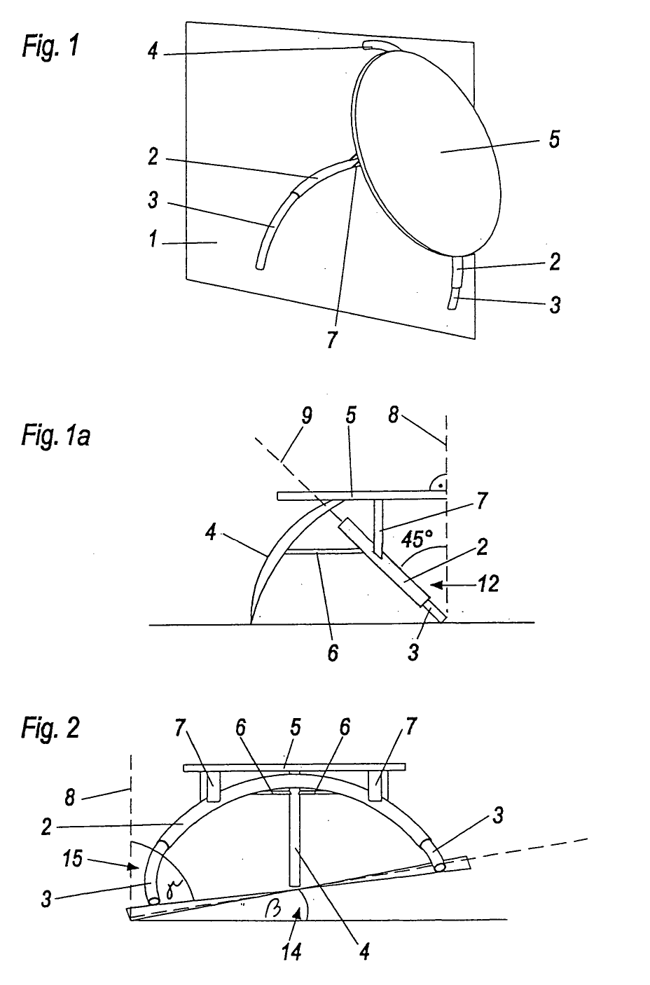

FIGS. 1 and 1a show a perspective view and a side view of an embodiment of a device according to the invention;

FIG. 2 shows said device being used according to the invention;

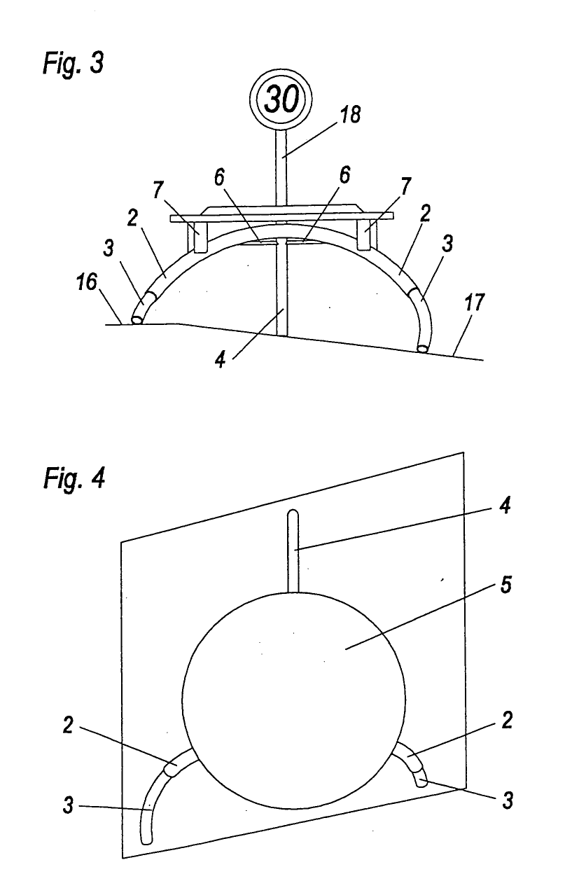

FIG. 3 shows an additional embodiment of the invention;

FIG. 4 shows a plan view of a device according to the invention;

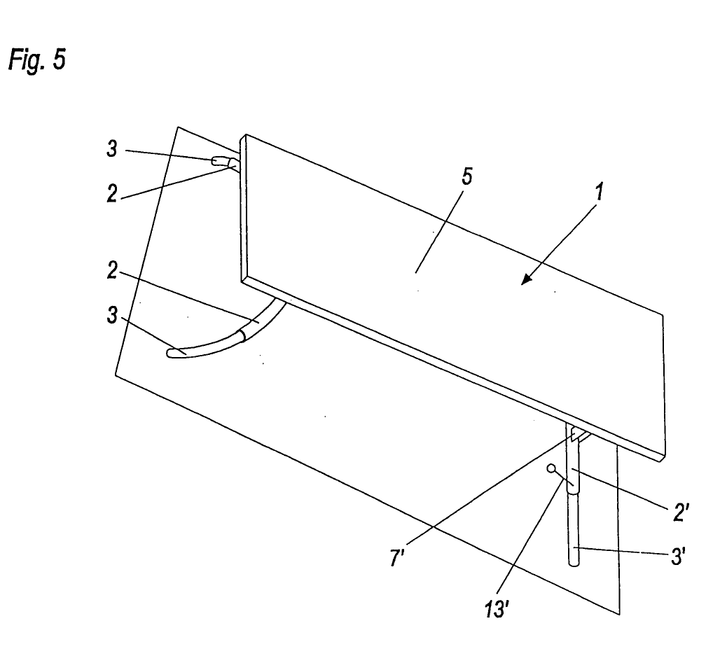

FIG. 5 shows an embodiment of a device according to the invention making use of two bows;

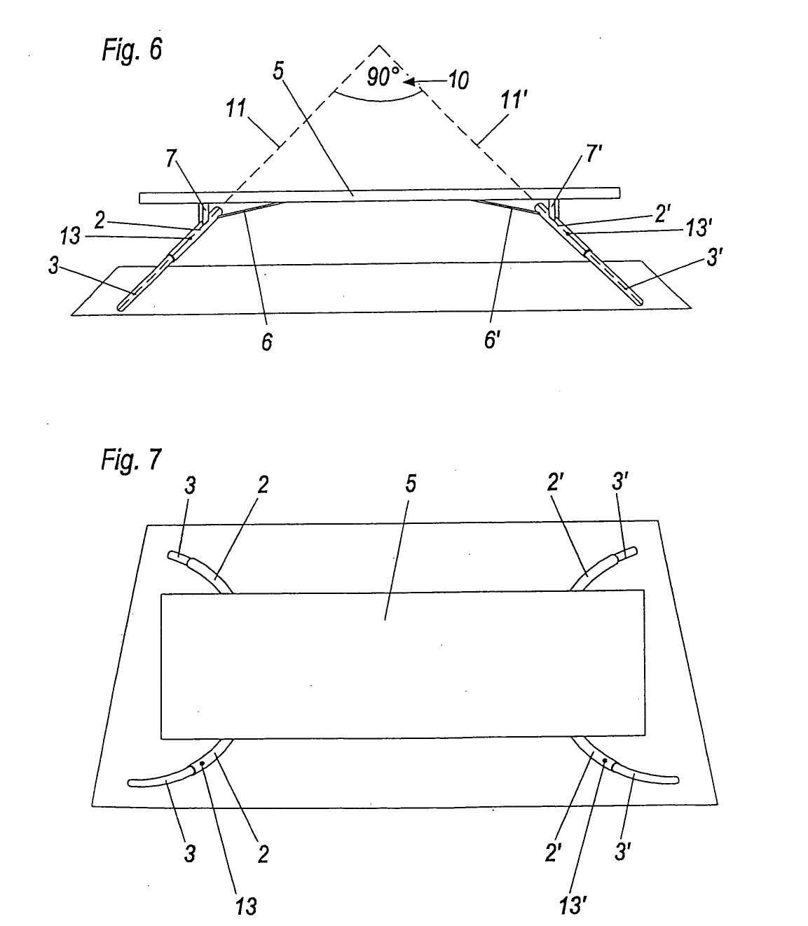

FIG. 6 shows a side view thereof;

FIG. 7 shows a plan view thereof;

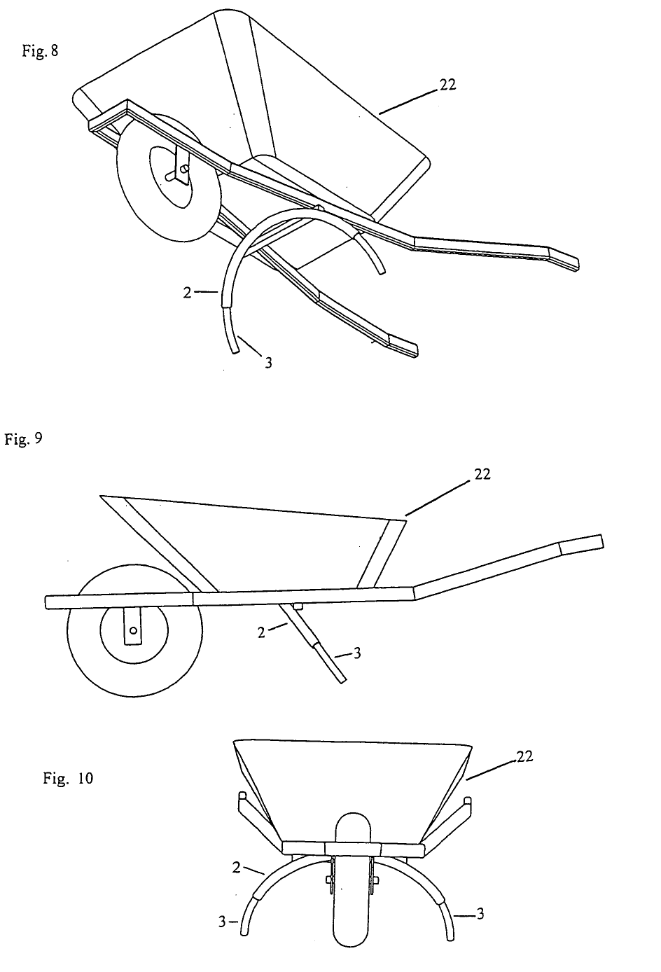

FIG. 8 shows a perspective view of an additional embodiment of a device according to the invention;

FIG. 9 shows a side view thereof;

FIG. 10 shows a front view thereof;

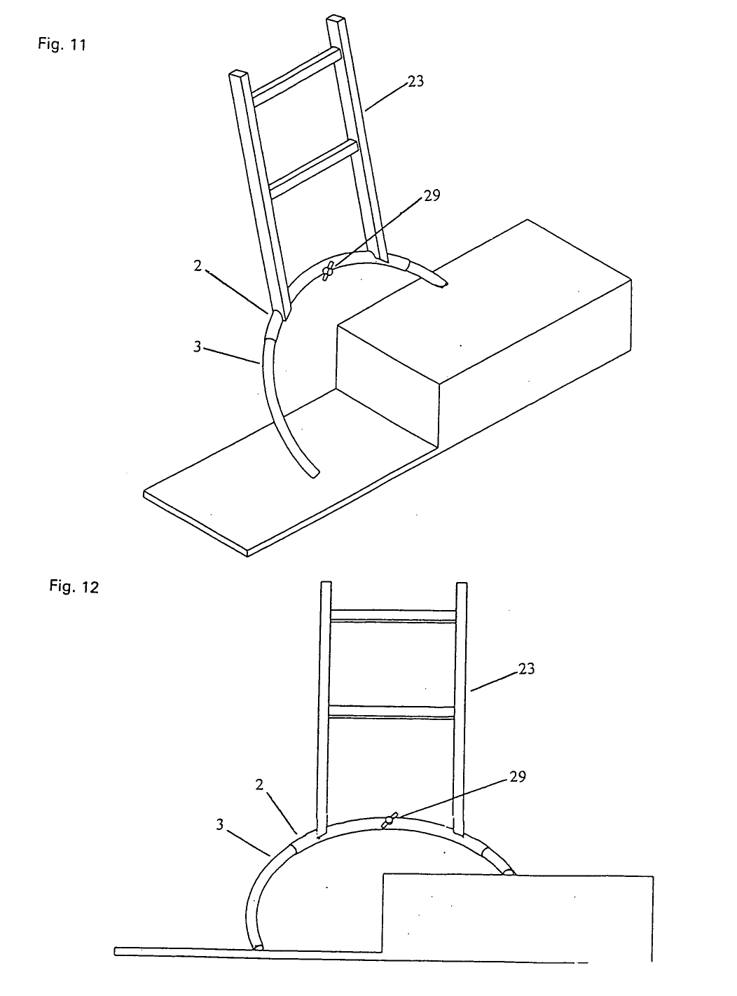

FIG. 11 shows a perspective view of an additional embodiment of a device according to the invention;

FIG. 12 shows of front view of this embodiment;

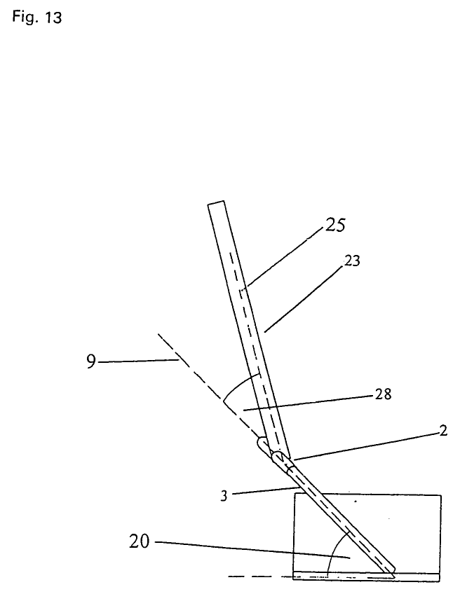

FIG. 13 shows a side view of this embodiment;

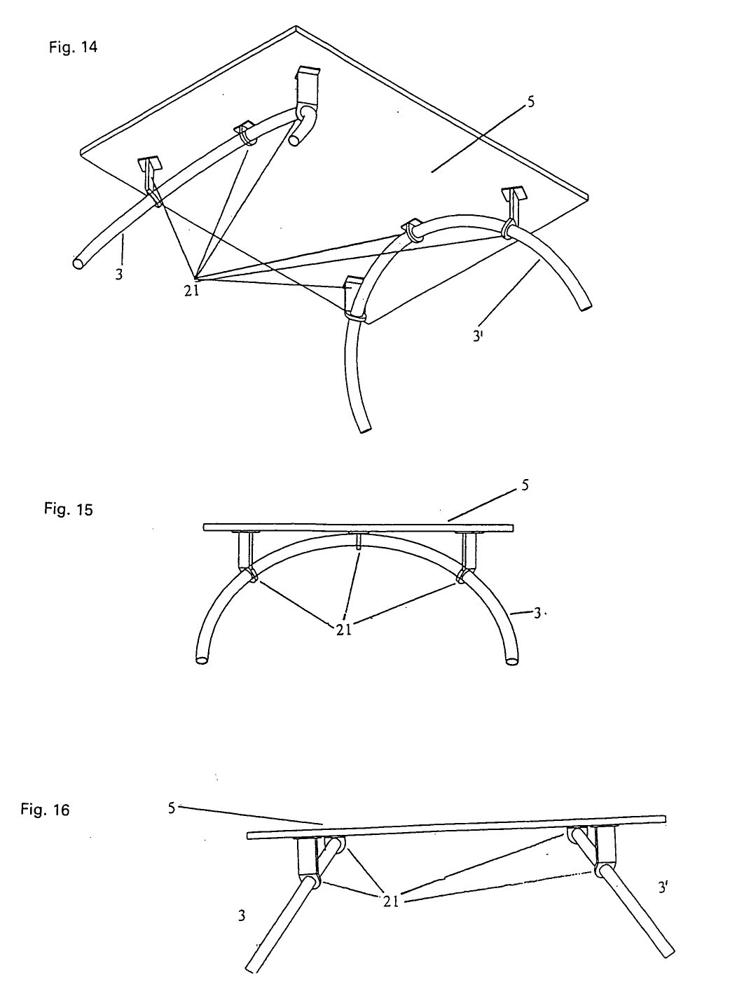

FIG. 14 shows a perspective view of an additional embodiment of a device according to the invention;

FIG. 15 shows a front view thereof;

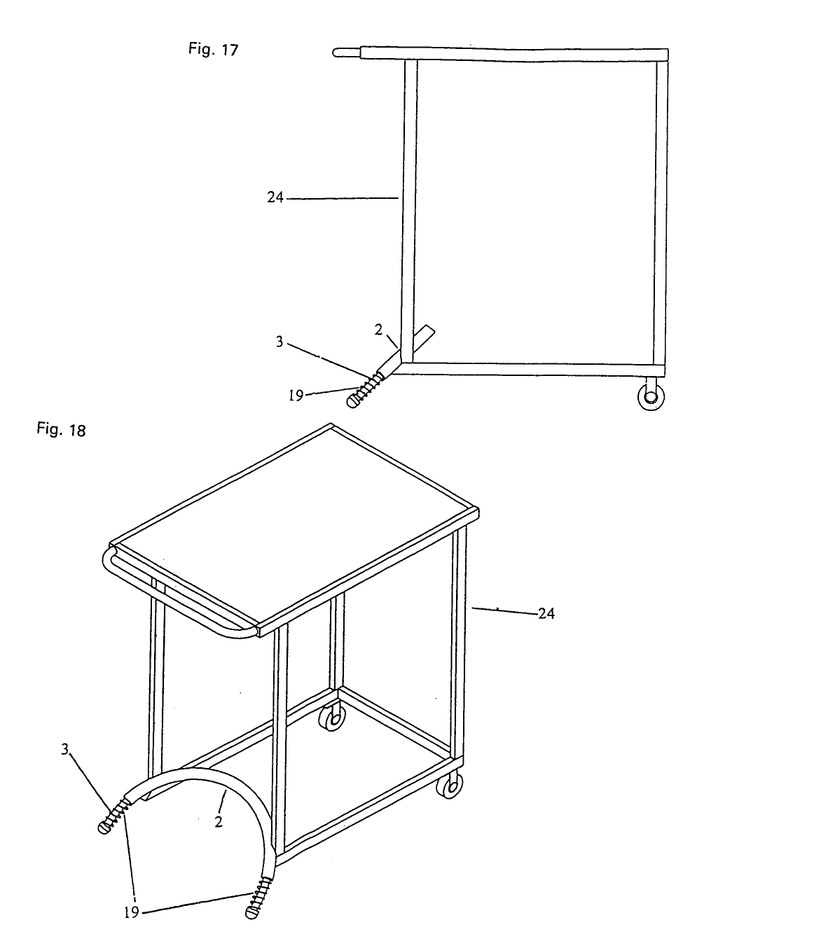

FIG. 16 shows a side view thereof;

FIG. 17 shows a side view of an additional embodiment of a device according to the invention;

FIG. 18 shows a perspective view thereof;

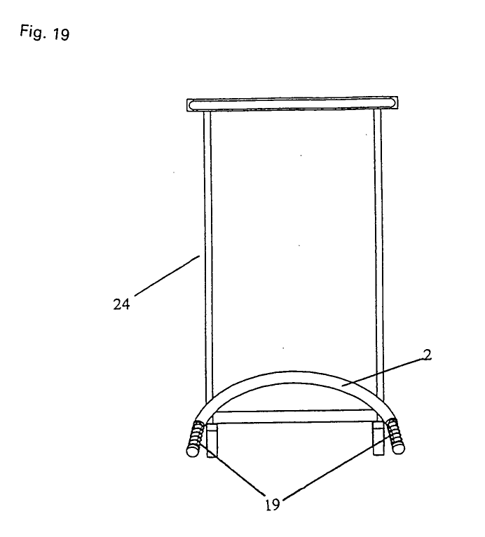

FIG. 19 shows a front view thereof;

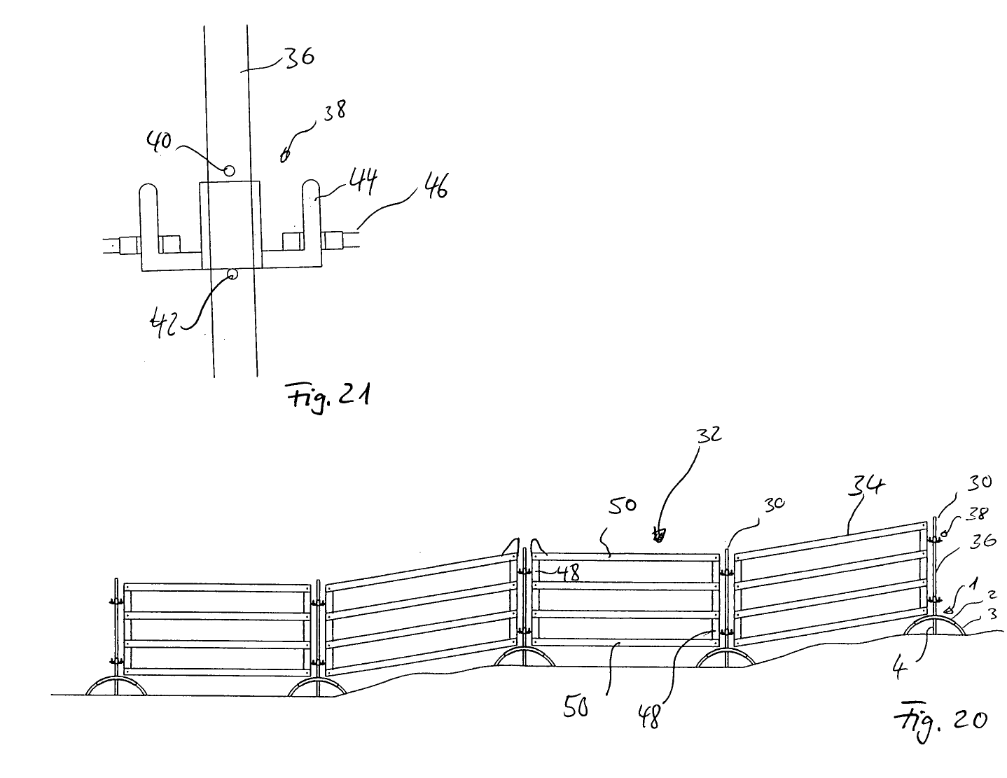

FIG. 20 shows a fence comprising a device according to the invention; and

FIG. 21 shows a detail relating to FIG. 20.

FIG. 1 illustrates a device 1 according to the invention comprising a bow 3 guided without play in a guide tube 2, with the bow 3 protruding from the guide tube 2 and a bent strut 4 being connected to the guide tube 2. Attached thereto is a circular plate constituting a supporting surface 5 on its top side. It can be seen in FIG. 1a that the plate is attached to the guide tube 2 via a vertical strut 7. The bent strut 4 is connected to the guide tube 2 via a supporting strut 6. It can be seen furthermore that the plane 9 in which the guide tube 2 extends includes an angle 12 of 45° with the perpendicular 8 to the supporting surface 5.

FIG. 2 illustrates the utilization of the device 1 according to the invention for gradient compensation on an inclined plane including an angle β 14 with the horizontal and an angle γ 15 with the perpendicular 8. It can be seen that the bow 3 on the deep or low side protrudes farther from the guide tube than the bow end 3 on the high side, thus providing for a horizontal orientation of the supporting surface 5.

FIG. 3 illustrates an additional example of application of the device according to the invention. In this case, one bow end 3 has been placed on a road edge 16, and the other bow end has been placed on a slope 17 inclined downwardly from the road. A road traffic sign 18 has been set up on the horizontally aligned supporting surface 5.

FIG. 4 shows the plan view of a device according to the invention as illustrated in FIG. 2.

FIG. 5 shows a perspective view of a further embodiment of a device 1 according to the invention making use of two guide tubes 2, 2′ each having an arc-shaped bow 3, 3′ arranged therein so as to be slidable without play. The guide tubes 2, 2′ are attached, via mounting struts 7, 7′, to a rectangular plate the top side of which constitutes the supporting surface 5.

FIG. 6 illustrates the side view pertaining thereto, which reveals that the planes 11, 11′ of the two guide tubes 2, 2′ include an angle 10 of 90° with each other. In addition thereto, it can be seen that the guide tubes 2, 2′ are connected to the plate via additional supporting struts 6, 6′.

FIG. 7 shows the plan view of the device illustrated in FIGS. 5 and 6.

FIG. 8 illustrates a wheelbarrow 22 in a perspective view, having a device according to the invention attached thereto. FIGS. 9 and 10 illustrate the side and front views pertaining thereto.

FIG. 11 shows a ladder 23 having attached thereto the guide tube 2 of a device according to the invention.

FIG. 12 shows the front view pertaining thereto. FIG. 13 shows that the plane 9 of extension of the guide tube forms an angle 28 with the plane 25 in which the ladder 23 extends. The effect achieved thereby is that the plane 9 forms an angle 20 of approx. 45° with the ground. In addition thereto, a clamping screw 29 may be provided for fixing.

FIGS. 14 to 16 illustrate an embodiment in which the guide tubes 2, 2′ have been replaced by rings 21.

FIGS. 17 to 19 illustrate a table trolley 24 having attached thereto a device according to the invention in place of the supporting legs. Furthermore, there are shown coil springs 19 arranged on the ends of the bow 3 protruding from the guide tube. The coil springs 19 constitute a resetting or centering means through which the bow in the unloaded state is returned to the original position thereof. In the embodiment illustrated, there are provided two coil springs between the bow ends and the guide means. Such a resetting means may be realized in principle with all of the various embodiments of the present invention. Instead of the coil spring 19, the resetting means may also comprise other resetting members, for example of rubber material or pneumatic ones. The resetting members may also be integrated in the guide means so as to be not too much exposed as illustrated in FIGS. 17 to 19. In addition thereto, with a discontinuous guide means, e.g. in case of guide rings or guide tube sections, the guide members may also be provided in the region of the middle of the arc-shaped bow. In most of the applications, they are clearly better protected there than at the tube ends. The bow may be provided with corresponding stops for springs.

FIGS. 20 and 21 illustrate a fence 32 comprising a device 1 according to the present invention. In particular, there can be seen vertical fence posts 30 having attached at the lower end thereof a device 1 according to the present invention. The device 1 is substantially a three-legged structure. However, it may be formed just as well with two bows 3. Horizontal fence members 34 are connected between the perpendicular fence posts 30 of fence 32.

In addition to the level compensation device 1 according to the invention, the fence post 30 basically just comprises a vertical rod 36 provided with connecting members 38 for connection of the horizontal fence members 37.

A connecting member 38 is shown more clearly in FIG. 21. The connecting member 38 illustrated in FIG. 21 is rotatably disposed on rod 36. It is rotabably supported between two pins 40, 42. Substantially vertically extending pegs 44 permit hooking up of corresponding connecting members 46 having the horizontal fence members 34 connected thereto. It is also possible to provide more than two pegs 44 distributed around the rod 36. This holds in particular in case the connecting member 38 is fixedly, instead of rotatably, connected to the rod 36.

A horizontal fence member 34 comprises at least two vertical struts 48 and at least two horizontal struts 50. The vertical struts 48 and the horizontal struts 50 are connected to each other in articulated manner so that the basically rectangular horizontal fence member 34, by parallel displacement of the two vertical struts 48 with respect to each other, may be shifted so as to form a skew rectangle. This permits the horizontal fence members 34 to extend substantially parallel to the ground. FIG. 20 shows particularly clearly how the fence 32 may be erected also on sloping ground.

Especially with respect to the fence, it is very expedient to make use of relatively lightweight materials, for example aluminum or aluminum alloys. This may be expedient also in other embodiments, for example for bistro tables, ladders etc. In case of materials having less favorable sliding properties on each other, it may be expedient to provide the bow 3 and/or the guide means 2 with a plastics material having favorable sliding properties. Optionally, parts of the device or the entire device may be produced of plastics material.

A device for height and gradient compensation, characterized in that an arc-shaped bow 3 is slidably arranged in an also arc-shaped guide tube 2, with the bow 3 protruding from the guide tube 2 preferably on both sides thereof.

Preferably, there is at least one bent strut 4 in connection with the guide tube 2.

The device preferably comprises at least one preferably planar supporting surface 5 that is connected to the guide tube 2 and/or the strut 4 preferably in rigid manner. The supporting surface 5 may be of circular or rectangular design.

Preferably, the plane 9 having the guide tube 2 extending therein includes an angle 12 of preferably between 30° and 60°, in particular of approx. 45°, with the perpendicular 8 to the supporting surface 5.

Preferably, there are at least two arc-shaped bows 3, 3′ slidably arranged in an also arc-shaped guide tube 2, 2′ each, with the bows 3, 3′ protruding from the respective guide tubes 2, 2′ preferably on both sides thereof and the respective guide tubes 2, 2′ being preferably attached to a common supporting surface 5. At least the planes 11, 11′ of extension of two guide tubes 2, 2′ may include an angle 10 of preferably 70° to 110°, preferably approx. 90°, with each other.

Preferably, the device 1 is provided with at least one respective fixing device 13, 13′ for fixing the bows 3, 3′ in the respective guide tubes 2, 2′.

The device may be connected to a movable object, preferably in rigid fashion.

The movable object may be a wheelbarrow 22 or a ladder 23 or a table trolley 24.

Preferably, the plane 9 in which the guide tube 2 extends forms an angle 28 of preferably between 0° and 90°, in particular of approx. 25°, with the plane 25 in which the ladder 23 extends.

Preferably, the bow 3 is frictionally fixed in the guide tube 2 under the influence of gravity. The outer diameter of the bow 3 may substantially correspond to the inner diameter of the guide tube 2.

The portions of the bow 3 protruding from the guide tube 2 may each have a coil spring 19 arranged thereon.

Preferably, the device 1 has attached thereto at least one fixing device 13 for fixing the bow 3 in the guide tube 2.

Instead of an arc-shaped guide tube 2, there may also be provided mutually spaced apart arc-shaped tube sections or rings 21.

1-23. (canceled)

24. A device for gradient compensation, comprising an arc-shaped bow slidably arranged in a guide means, the bow protruding at least on one end from the guide means and said at least one bow end constituting a standing leg for the device, at least one additional supporting member, said guide means being a rigid guide means, the bow being joined to the device under an angle, and the bow, in use, being arranged at an angle with respect to the perpendicular such that the bow is frictionally fixed in the guide means under the influence of gravity.

25. A device according to claim 24, wherein the angle with respect to the perpendicular is between 30° and 60°.

26. A device according to claim 24, wherein the angle with respect to the perpendicular is approximately 45°.

27. A device according to claim 24, further comprising a resilient resetting means disposed such that the resetting means is capable of operationally resetting the arc-shaped bow in the unloaded state to the initial position thereof.

28. A device according to claim 27, wherein the resetting means comprises two coil springs each attached on one of the portions of the bow protruding from the guide means.

29. A device according to claim 24, further comprising an outer diameter of the bow corresponds substantially to an inner diameter of the guide means.

30. A device according to claim 24, wherein the guide means is an arc-shaped guide tube.

31. A device according to claim 24, wherein the guide means is formed of mutually spaced apart arc-shaped tube sections or rings.

32. A device according to claim 24, further comprising a supporting surface.

33. A device according to claim 32, wherein the supporting surface is rigidly joined to the guide means and/or the at least one additional supporting member.

34. A device according to claim 32, wherein the guide means and the bow extend in a plane and the plane includes an angle with the perpendicular to the supporting surface which is preferably between 30° and 60°.

35. A device according to claim 34, wherein the angle is approximately 45°.

36. A device according to claim 24, wherein the at least one additional supporting member is a strut.

37. A device according to claim 24, wherein the at least one additional supporting member is an arc-shaped bow slidably disposed in a guide means.

38. A device according to claim 37, wherein respective planes of extension of two guide means include an angle with each other which is preferably from 70° to 110°.

39. A device according to claim 38, wherein the angle is approximately 90°.

40. A ladder comprising a device according to claim 24, wherein the at least one additional supporting member is an upper free end of the ladder.

41. A ladder according to claim 40, wherein the plane of extension of the guide mans includes an angle with the plane in which the ladder extends which is preferably between 0° and 90°.

42. A ladder according to claim 41, wherein the angle is approximately 25°.

43. A road traffic sign comprising a device according to claim 24.

44. A wheelbarrow comprising a device according to claim 24, wherein a wheel of the wheelbarrow constitutes the at least one additional supporting member.

45. A motorcycle comprising a device according to claim 24, wherein the bow is joined to the motorcycle as a rotatable main stand and a front wheel or a rear wheel of the motorcycle constitutes the at least one additional supporting member in use of the device.

46. A table comprising a device according to claim 24.

47. A fence comprising vertical fence posts and horizontal fence members connected thereto, wherein at least one of the fence posts comprises a device according to claim 24.

48. A fence according to claim 47, wherein each vertical fence post is substantially a rod having at a lower end thereof the arc-shaped bow and a strut.

49. A fence according to claim 47, wherein the vertical fence posts are provided with connecting members for hooking the horizontal fence members, and the horizontal fence members are provided with corresponding connecting members.

50. A fence according to claim 47, wherein at least one of the horizontal fence members is formed of at least two vertical struts and at least two horizontal struts that are connected to each other in articulated fashion such that the vertical struts are displaced parallel to each other in a plane of the horizontal fence members.
